(19) United States
(12) Patent Application Publication
(10) Pub. No.: US 2019/0257771 A1
(43) Pub. Date: Aug. 22, 2019

(54) Sensor System For Detection Of Material Properties

(71) Applicant: Heriot-Watt University, Edinburgh Central Scotland (GB)

(72) Inventors: Marc Philippe Yves Desmulliez, Edinburgh Central Scotland (GB); Sumanth Kumar Pavuluri, Edinburgh Central Scotland (GB); George Goussetis, Edinburgh Central Scotland (GB)

(21) Appl. No.: 16/346,097

(22) PCT Filed: Oct. 31, 2017
(86) PCT No.: PCT/GB2017/053275

§ 371 Date: Apr. 29, 2019

(30) Foreign Application Priority Data
Oct. 31, 2016 (GB) 1618380.8

(51) Int. Cl. G01N 22/04; H01Q 13/02; H01P 3/16

(52) U.S. Cl. CPC G01N 22/04; H01P 3/16; H01Q 13/02

(57) ABSTRACT

A materials characteristic sensor system (40), comprising a sensor comprising a waveguide, and a transceiver (2) for transmitting a continuous wave signal (389) to be incident on a material (32) to be characterised, wherein the sensor is operable to receive a reflected continuous wave signal (399) reflected from the material, and wherein a characteristic of the material is determined using at least one of a resonance frequency difference, a magnitude difference, or a Q factor difference due to the material interacting with the transmitted continuous wave signal.

### TECHNICAL FIELD OF THE INVENTION

This invention relates to (1) transceiver architectures used in the detection of frequency modulated signals for a sensor system (2) the sensor configurations for transmitting and receiving the frequency modulated signals and (3) the measurement method from the received frequency modulated signals to determine material properties or characteristics of materials under detection.

### BACKGROUND OF THE INVENTION

Frequency-modulated radio systems have been in existence since the 1930's (U.S. Pat. No. 2,257,830A) in terrain clearance indicators, radio altimeters, and radio distance and velocity indicating apparatus. Military applications such as target detection and monitoring have been predominantly the main focus of these systems. Frequency Modulated Continuous Wave (FMCW) radars systems have also been used for remote sensing applications such as the detection of soil, land and snow. Since the 1970's, FMCW based radar level gauging has been the leading measuring principle for high accuracy applications primarily for industrial liquid tanks and vessels. Accurate level measurement is required for inventory control and custody transfer in industries where liquids such as oil, tar, chemicals and other materials are stored in large tanks. In the automobile industry there exists prior art for monostatic FMCW radar sensors in automotive applications (U.S. Pat. No. 6,037,894A) for the detecting of objects for collision avoidance.

Current FMCW radars operate on the homodyne principle. The oscillator serves as both the transmitter and local oscillator. A FMCW radar for level measurement transmits into the tank a signal which is swept over a frequency range in the order of a few GHz. For example, the signal can be in the range 24.05-26.5 GHz, or 8.5-10.6 GHz etc. The transmitted signal is reflected by the surface of the product in the tank and an echo signal, which has been delayed a certain time, is returned to the radar level meter equipment. The echo signal is combined with the transmitted signal in a mixer to generate a combined signal known as the beat frequency signal. This signal has a frequency equal to the frequency change of the transmitted signal that has taken place during the time delay. If a linear sweep is used, this frequency, which is also referred to as Intermediate Frequency (IF), is proportional to the distance between the radar and the reflecting surface. Such systems also employ various methods to attempt to correct the non-linearity of the swept waveform.

Hybrid analog/digital implementations of tracking filters serve to process the signal such that the frequency of the mixer output signal can be correctly estimated and the liquid level can be determined.

Such a system would also desirably use all digital processing by using first a receiver amplifier to minimize contributors to the measurement error, and then by using digital processing algorithms to further minimize part count and improve reliability.

More recently, the FMCW principle has been improved through the transmission of not a continuous frequency sweep but using a constant amplitude sweep of stepped frequency (U.S. Pat. No. 5,406,842A). When the transmitted and received signals are mixed, each frequency step will provide one constant piece of a piecewise constant IF-signal. The piecewise constant IF-signal is sampled and the sampled signal is usually transformed into frequency spectrum by using techniques such as an Fast Fourier Transform (FFT), so that the IF signal is transferred into a distance domain to deduce the distance and target range parameters.

Also conventional FMCW systems (continuous as well as stepped) are relatively power hungry, making them less suitable for applications where power is limited. Examples of such applications include field devices powered by a two-wire interface, such as a 4-20 mA loop, and wireless devices powered by an internal power source (e.g. a battery or a solar cell). There exist solutions to reduce the power requirements for these kinds of FMCW systems (U.S. Pat. No. 8,497,799B2).

The FMCW radar sensors in the prior art are primarily operated in the far-field regime. For the antenna, which transmits and receives, the signal has a bandwidth at least equal to the total frequency sweep bandwidth of the FMCW. For example for an FMCW radar transceiver with frequency sweep from 9.5 GHz to 10.5 GHz (sweep bandwidth of 1 GHz), the antenna which acts as a sensor and with a bandwidth which must also be at least 1 GHz centred at 10 GHz in order to detect the beat frequency. Conventional FMCW radar sensors are primarily intended for range, distance, velocity and object presence detection. These conventional FMCW radar sensors are not designed to provide any quantitative measurement of the materials under test or liquids that flow in a pipe.

In such systems, the beat frequency of the IF signal is the only parameter of interest. In many applications there are relatively high demands on the accuracy of the resonant frequency shift and Q factor shift for detecting these parameters.

KRAUSE H-J ET AL: “Dielectric microwave resonator for non-destructive evaluation of moisture and salinity” discloses a sensor with a dielectric resonator made of Barium Zirconium Titanate ceramic. The resonator has a lid fabricated from Teflon/PTFE foil to increase the quality factor of the resonance.

EP 1116951 A1 discloses a measuring system with a dielectric resonator that has a plane close to or in contact with a sample. The surfaces of the dielectric resonator may be covered with a substance such as PTFE or quartz.

WO00/28615 discloses a dielectric or dielectrically filled metal waveguide which is used as a microwave resonator in a sensor system to e.g. determine properties of a material.

WO 2013164627 A1 discloses a dielectric waveguide which is used as a microwave resonator with a dielectric reflector to enhance the sensing field intensity in a sensor system to e.g. determine properties of a material.

It is therefore an object of the present invention to provide apparatus for the detection and quantitative measurement with a high degree of resolution of material characteristics.

Additional objects, invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

At its most general, the invention provides for quantitative measurement of a characteristic of a material (e.g. materials properties, e.g. physical properties) by the use of at least one of: a resonance frequency difference; a magnitude difference; a Q factor difference, in a transmitted/reflected continuous wave microwave signal. These differences/changes have been found to occur due to the material interacting with (e.g. providing a reflection of) the transmitted continuous wave microwave signal. Preferably, an Intermediate Frequency (IF) signal is used for this purpose, obtainable by combining/mixing the transmitted continuous wave and the reflected continuous wave. Preferably, use is made of the IF signal beat frequency, and/or a shift in beat frequency of the IF signal and/or a change of amplitude of the beat frequency signal, arising due to the presence of a material(s) being sensed.

In accordance with a first aspect of the present invention, there is provided a materials characteristic sensor system, comprising: a sensor comprising a waveguide: and a transceiver for transmitting a continuous wave signal to be incident on a material to be characterised, wherein the microwave sensor is operable to receive a reflected continuous wave microwave signal reflected from the material, and wherein a characteristic of the material is determined using at least one of a resonance frequency difference, a magnitude difference, or a Q factor difference due to the material interacting with the transmitted continuous wave microwave signal. Most preferably, the characteristic of the material is a materials characteristic(s), for example, being one or more of: composition, density, volume, humidity, moisture content, porosity, permeability, size, mass, surface roughness or a combination of any number thereof. The materials characteristic(s) may be a material/physical property of the material.

Desirably, the transceiver is arranged to combine the continuous wave signal and the reflected continuous wave signal, and analyse the resulting beat frequency signal (or IF signal) to determine the characteristic of the material.

Desirably, the transceiver is arranged to sample the beat frequency signal (or IF signal) by digitising an analogue measurement curve based on the reflected continuous wave signal; and, using at least one characteristic of the sampled beat frequency signal (or IF signal): e.g. by the use of at least one of: a resonance frequency difference; a magnitude difference; a Q factor difference, in a transmitted/reflected continuous wave microwave signal, to determine the characteristic of the material.

The transceiver may comprise a mixer and the transceiver may be arranged to obtain the beat frequency or the sampled IF signal after the mixer by incrementing a frequency of the continuous wave signal in a plurality of steps for the entirety of a sweep range of the continuous wave signal, digitising a resultant IF signal obtained after the mixer, and sampling the resultant IF signal at an analogue to digital converter (ADC). The transceiver may comprise a mixer and the transceiver may be arranged to obtain the beat frequency or the sampled IF signal after the mixer by: sweeping a frequency of the continuous wave signal continuously in time for the entirety of a sweep range of the continuous wave signal to produce an IF signal; digitising a resultant IF signal obtained after the mixer; and sampling the resultant IF signal at an analogue to digital converter (ADC).

Desirably, the transceiver may be arranged to analyse a resulting peak magnitude, and/or an equivalent resonant frequency and/or a Q factor equivalent of the resulting IF signal to determine the characteristic of the material.

In some examples, the waveguide comprises a hollow, open-ended body that acts as a conduit for transmitting and receiving signals. In some examples, the body has a first end and a second end, opposite the first, and wherein the transceiver is positioned adjacent the body at the first end.

In some examples, the sensor system further comprises a signal permeable window positioned at the second end of the body, wherein the microwave permeable window closes the second end of the body. In some examples, the waveguide is filled with a dielectric or dielectric material for creating a resonance. In some examples, the signal permeable window is a dielectric reflector, the dielectric reflector being operable to cause formation of a sensing field by increasing the intensity of the electromagnetic fields beyond its outer surface or below its inner surface, the dielectric reflector having a thickness of at least λ_{g}/20, where λ_{g} is the wavelength of the excited electromagnetic wave in the dielectric reflector, wherein the dielectric reflector is made of a dielectric material that is different to that of the dielectric material in the waveguide, and wherein the dielectric reflector causes formation of a sensing field beyond its outer surface or below its inner surface, and wherein the electromagnetic fields extend beyond the dielectric reflector, wherein the microwave sensor is arranged to allow the sensing fields for the transmitting and receiving signals at the excitation wavelength and to measure any variation in the received signal due to the material interaction of the transmitted signal.

In some examples, the signal permeable window is adapted to be inserted into a fluid containing body. In specific examples, the fluid containing body is a pipeline, and the fluid is moving.

In some examples, the characteristic of the material is at least one of: composition, density, volume, humidity, moisture content, porosity, permeability, size, mass, surface roughness, surface position, absolute position, or distance, or any combination or two or more thereof.

In some examples, the sensor system comprises a concentrator arranged around the waveguide. In specific examples, the concentrator is a DBR (distributed Bragg reflection) structure.

In some examples, the transceiver is operable to generate a broadband microwave signal, millimetre wave signal or RF (Radio Frequency) spectrum signal. In specific examples, the transceiver is adapted to cause the sensor to operate in a far-field mode. In other specific examples, the transceiver is adapted to cause the sensor to operate in a near-field mode.

In accordance with a second aspect of the present invention, there is provided a method of determining a characteristic of a material, the method comprising: transmitting a continuous wave signal to be incident on the material; receiving a reflected continuous wave signal reflected from the material; and determining a characteristic of the material using at least one of a resonance frequency difference, a magnitude difference, or a Q factor difference due to an interaction of the material with the continuous wave signal.

In some examples, the determining step further comprises: sampling an IF signal by digitising an analogue measurement curve based on the reflected continuous wave signal; and using at least one characteristic of the sampled IF signal to determine the characteristic of the material.

In some examples, the method further comprises: combining the continuous wave signal and the reflected continuous wave signal; and analysing the resulting beat frequency or the sampled IF signal to determine the characteristic of the material.

In some examples, the step of analysing comprises obtaining the beat frequency or the sampled IF signal after a mixer by: incrementing a frequency of the continuous wave signal in a plurality of steps for the entirety of a sweep range of the continuous wave signal; digitising a resultant IF signal obtained after the mixer; and sampling the resultant IF signal at an analogue to digital converter (ADC).

In some examples, the step of analysing comprises obtaining the beat frequency or the sampled IF signal after a mixer by: sweeping a frequency of the continuous wave signal continuously in time for the entirety of a sweep range of the continuous wave signal to produce an IF signal; digitising a resultant IF signal obtained after the mixer; and sampling the resultant IF signal at an analogue to digital converter (ADC).

In some examples, the method comprises analysing a resulting peak magnitude, and/or an equivalent resonant frequency and/or a Q factor equivalent of the resulting IF signal to determine the characteristic of the material.

In some examples, the characteristic of the material is one of: composition, density, volume, humidity, moisture content, porosity, permeability, size, mass, surface roughness, surface position, absolute position, distance, or a combination of any thereof.

In accordance with a third aspect of the present invention, there is provided a system for determining a characteristic of a material; comprising: a materials characteristic sensor system as set out above; a control board adapted to control the transmission and reception of a continuous wave signal and a reflected continuous wave signal; and a processor adapted to implement a method as set out above.

In one aspect of the present invention, a path circuitry of the transceiver may be adapted to transmit a stepped frequency including having a centre frequency that is sweepable across a frequency band and having a control signal to sweep, a receiver circuit with a mixer to multiply the transmitted and received signal producing an IF (Intermediate Frequency) signal followed by a bandpass filter that is configured to determine the target or material under test parameters at a close range. In addition, the path circuitry of the receiver can include an analog-to-digital converter (ADC) to sample an output from the bandpass filter at a sampling frequency that is dependent upon a sampling clock input to the ADC.

Preferably, there exists a sweepable bandpass filter whose bandwidth may be less than the bandwidth of the complete IF (Intermediate Frequency) band. Desirably, instead of selecting the sampling frequency based on baseband Nyquist sampling criteria or bandpass Nyquist sampling criteria with respect to the total swept bandwidth, the sampling frequency may be selected such that one or more Nyquist zones are crossed as the bandpass filter is swept across the frequency band. Desirably, the receiver path circuitry may include signal processing circuitry configured to further process the digital signals received from the ADC. The filter sweep control circuitry may include error detection circuitry configured to determine a difference between the measured profile of the received signal and an expected profile for a received signal for a particular material under test or the target. Desirably, the sweepable bandpass filter may be configured to have an adjustable bandwidth that is controlled by a bandwidth control signal. Desirably, the filter sweep control circuitry may be configured to sweep the centre frequency for the sweepable bandpass filter to track characteristics for a desired signal to be detected based on the known target or material under test. The desired signal may be, for example, a signal not known to exist and its existence is being detected, and/or a signal known to exist and its existence is being confirmed. As described below, other features and variations can be implemented, if desired and related methods can also be utilized.

In another aspect, the present invention may provide a transceiver path circuitry configured to transmit a stepped frequency. Desirably, the receiver has a centre frequency that is sweepable across a frequency band and is configured to receive a control signal to sweep, and the receiver circuit further comprises a mixer to multiply the transmitted and received signal through an antenna. Desirably, the arrangement may further serve as a sensor that has a bandwidth smaller than the frequency of the transceiver module, producing an IF signal. Desirably, this is followed by a bandpass filter and a computer system that is configured to determine the target or material under test parameters at a close range. Desirably, the receiver path circuitry can include an analog-to-digital converter (ADC) coupled or configured to sample an output from the sweepable bandpass filter at a sampling frequency that is dependent upon a sampling clock input to the ADC. Desirably, the bandwidth for the sweepable bandpass filter may be less than a bandwidth for the intended IF frequency band.

The above and other features and advantages of the present invention will be better understood from the following detailed description taken in conjunction with the accompanying drawings.

Desirably, the antenna module of the sensor system may have a sensor frequency bandwidth in essence smaller then frequency sweep of the FMCW. The antenna may be a sensor, such as a simple horn antenna, a simple microwave cavity in near field and/or far field mode and any other simple free space antenna in far-field mode. The output of the mixer for the sensor is preferably the multiplication of the transmitted and received signal. The IF signal is usually obtained by mixing the reflected signal with the transmit waveform and convolving with the effective reflection coefficient of the sensor which can be a function of the bandwidth of the sensor. If the bandwidth of the sensor is smaller than the frequency sweep, one can thus represent the IF output by convolving the beat frequency response of the FMCW system with a bandwidth equal to the FMCW sweep and the reflection coefficient of the sensor.

In another aspect, the present invention may provide a method for effectively determining the physical parameters of materials under test or target from the band pass IF signal after the mixer by the use of appropriate classifications algorithms. Desirably, the stepped frequency transmitter/receiver provides a first stepped frequency microwave signal to the sensor to be transmitted to the material under test or to the target to be measured. The stepped frequency transmitter/receiver receives a second stepped frequency microwave signal in response to the first stepped frequency microwave signal. Desirably, a signal processor provides processing of a measuring signal derived from the stepped frequency microwave signal and the received signal to determine the properties of the material or target.

Desirably, the present invention may also provides a method of recognising a target or material under test comprising receiving FMCW based sensor returns from a target or material and processing the returns to achieve acceptable measurement of material properties including the concentration of ingredients of the fluid, the concentration of solids in the fluid, the concentration of water, or material characteristics in general through multiple parameter extraction from the IF (Intermediate Frequency) detected signal. The invention may provide the advantage of identifying the material feature vector in combination with using modelling techniques to indicate a member of a particular class of materials without recourse to a large database of FMCW based sensor data signatures.

Desirably, the method includes arranging for materials or targets to be encompassed within a single sensor range cell that corresponds to a fixed distance of the material or target from the sensor. It may involve processing of FMCW based sensor returns to obtain a sequence of spectra for each target and producing therefrom a sequence of feature vectors, and using modelling to identify the sequence of feature vectors as indicating a member of a particular class of targets or materials. This enables classification to use linked profiles as part of a material properties observation sequence: it exploits the fact that FMCW based sensor data for a material/target provides a series of profiles each offset slightly in time, amplitude. The parameters corresponding to perturbation of frequency due to material/target, the Q factor of the sensor can also be transformed into the time and amplitude axes of the IF signal of the FMCW based sensor. Each material profile is different, but over a sequence of observations the shape of the profile varies accordingly to some deterministic process. This embodiment exploits useful information in the variation of the material profile with time.

### BRIEF DESCRIPTION OF THE DRAWINGS

The present invention will be described in more detail with reference to the appended drawings, showing currently preferred embodiments of the invention.

FIG. 1 shows the block diagram of the FMCW transceiver module based sensor system with the signal transmission, receiving and processing;

FIG. 2 (a) shows the block diagram of the FMCW transceiver module based sensor system interfaced to a horn antenna. (b) Shows the block diagram of the FMCW transceiver module based sensor system interfaced to a horn antenna and further to a pipe section;

FIG. 3 (a) shows the block diagram of the FMCW transceiver module based sensor system interfaced to an open ended microwave cavity sensor (b) shows the block diagram of the FMCW transceiver module based sensor system interfaced to an open ended microwave cavity sensor and further to a pipe section;

FIG. 4 (a) shows the block diagram of the FMCW transceiver module based sensor system interfaced to a high Q open-ended microwave cavity sensor. (b) Illustration of the detailed schematic of high Q microwave cavity sensor probe. (c) shows the block diagram of the FMCW transceiver module based sensor system interfaced to a high Q open-ended microwave cavity sensor and further to a pipe section;

FIG. 5 shows the schematic of an open ended microwave cavity sensor interfaced to a flow pipe;

FIG. 6 shows the schematic of an open ended microwave cavity sensor to measure in a solid material;

FIG. 7 shows the electric field distribution in the open ended microwave cavity sensor without the dielectric reflector (item 101, FIG. 6);

FIG. 8 shows the electric field distribution in the open ended microwave cavity sensor showing the effect of the dielectric reflector 101;

FIG. 9 (a) shows the schematic showing the frequency sweep from the FMCW frequency transmitter. (b) Frequency sweep illustration of the transmitter sweeps and the received frequency;

FIG. 10 shows the schematic of the reflection coefficient of a horn antenna;

FIG. 11 shows the schematic of IF output of the FMCW interfaced to a reference antenna (horn antenna with Q=0.01 as an example);

FIG. 12 shows the IF output of the FMCW sensor interfaced with the horn antenna with Q=0.5 (as an example) after the IF filter;

FIG. 13 shows the reflection coefficient of a single mode resonant open ended microwave cavity resonant with Q=50 taken as an example;

FIG. 14 shows the IF output of the FMCW sensor interfaced with the open ended microwave cavity with Q=50;

FIG. 15 shows the reflection coefficient of a single mode high Q open ended microwave cavity with Q=500;

FIG. 16 shows the IF output of the FMCW sensor interfaced with a high Q open ended microwave cavity with Q=500;

FIG. 17 shows a detailed schematic of processing system 24 as shown in FIGS. 1, 2, 3 and 4;

FIG. 18 shows a flow diagram illustrating the series of routines to be executed for training by the processing system 24;

FIG. 19 shows the raw IF signal data plot due to response of the sensor for dairy cream material measured with a microwave cavity sensor 2 for different concentrations of water in the dairy cream product;

FIG. 20 shows a flow diagram illustrating the series of routines to be executed by the processing system 24.

### DETAILED DISCLOSURE

In the following detailed description, reference is made to the accompanying drawings that form a part hereof, and in which is shown by way of illustration specific illustrative embodiments. However, it is to be understood that other embodiments may be utilized and that logical, mechanical, structural and electrical changes may be made. Furthermore, the method presented in the drawing figures and the specification is not to be construed as limiting the order in which the individual steps may be performed. The following detailed description is, therefore, not to be taken in a limiting sense.

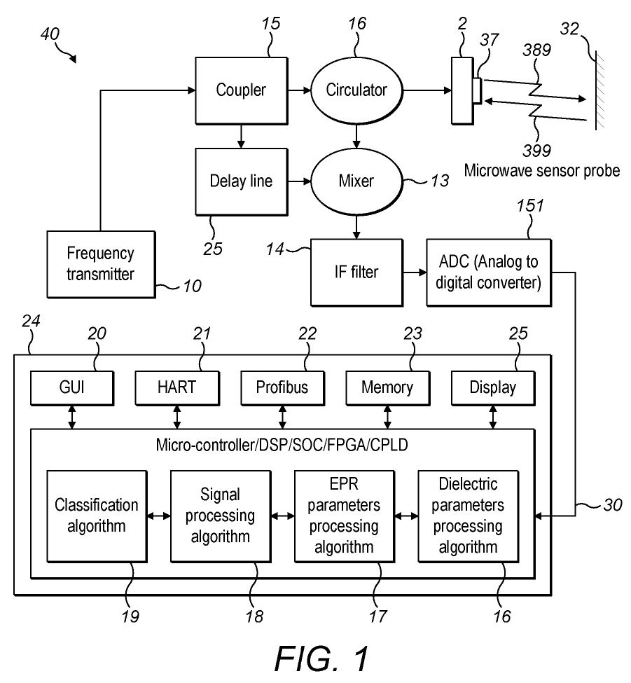

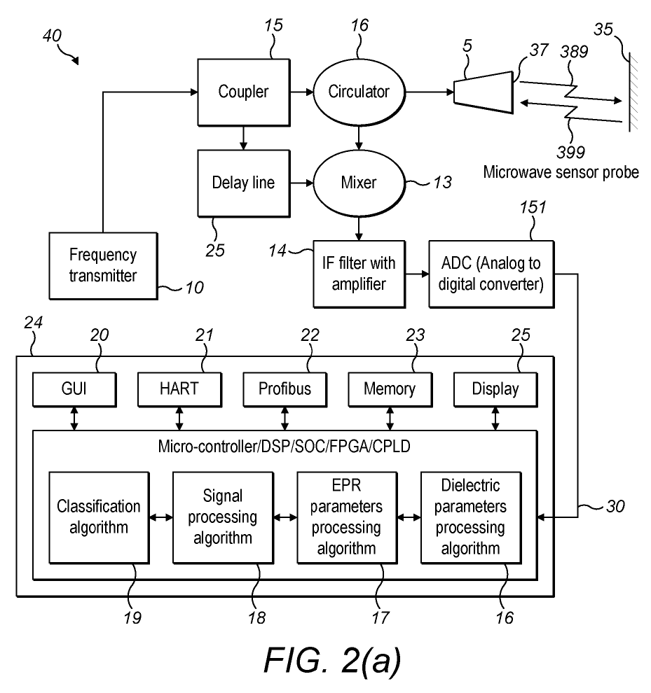

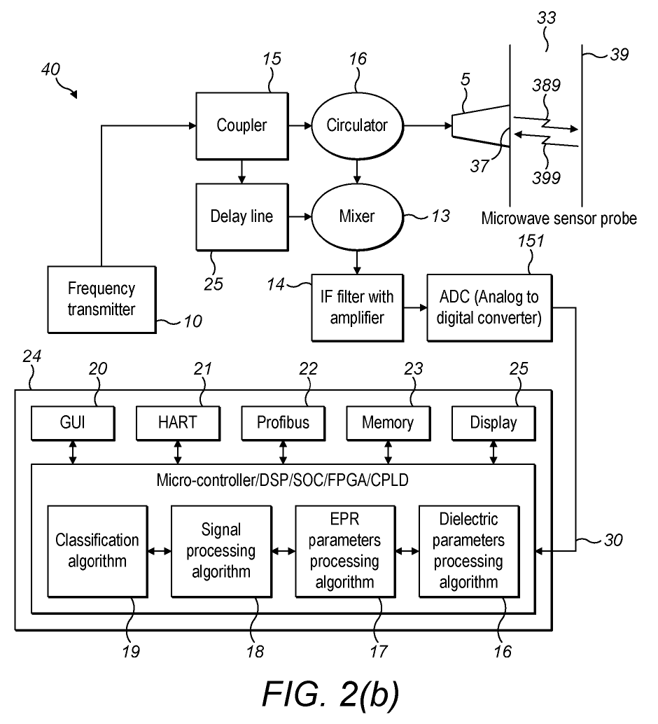

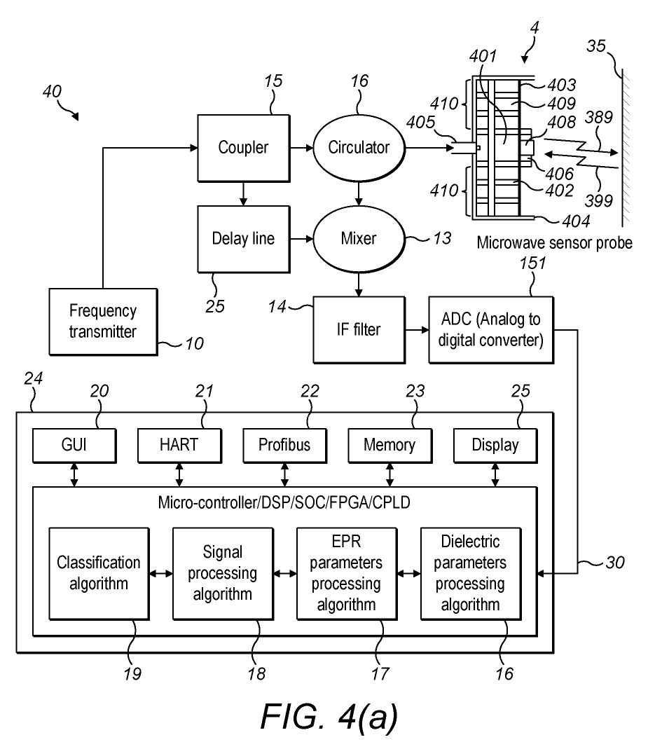

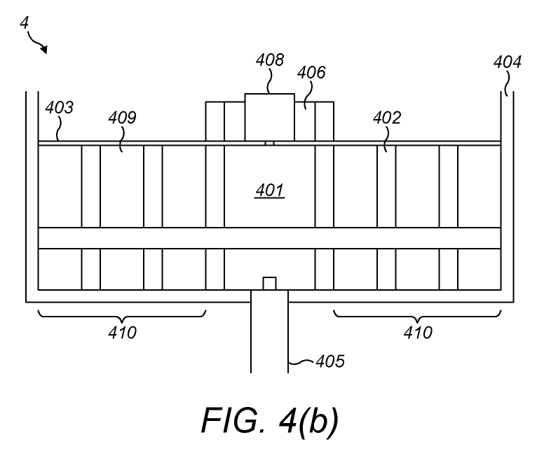

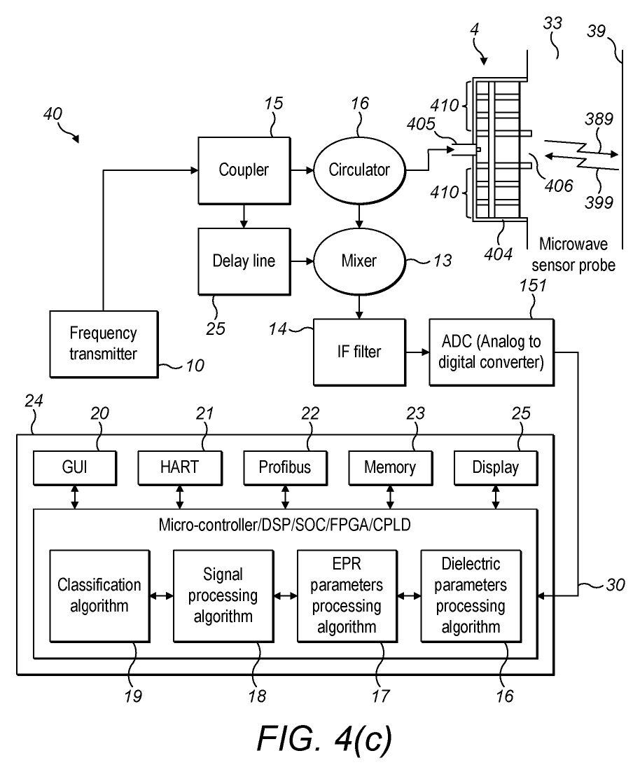

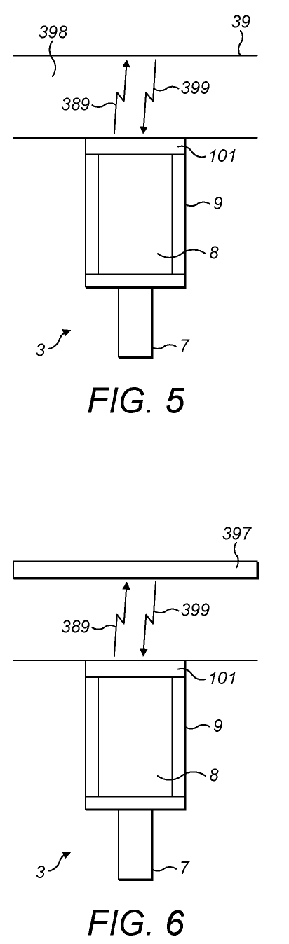

FIG. 1 shows a block diagram of a combination transmitter, receiver, signal processing system and data classification routine block for the detection of material characteristics mounted on to an antenna assembly 2 in accordance and that constitutes an FMCW module with the preferred embodiment of the invention. The material characteristics measuring device as shown in FIG. 1 comprises of a FMCW sensor system 40 that further comprises of a stepped frequency transmitter unit 10, a signal processor unit 24, and an antenna 2 (which is shown in the preferred embodiment of FIG. 5 as an open ended microwave cavity sensor 3 and also as high Q microwave cavity sensor as in FIG. 4 (b) or as a horn antenna 5 as in FIG. 2). The transmitter unit 10 may comprise of a microwave frequency generator coupled to a frequency select control. The FMCW based sensor 40 can transmit and receive from a single antenna 2 with high sensitivity. A circulator 16 couples a transmit signal to the antenna 2 and also couples the received signal to the mixer 13 but provides some isolation of the receive signal from the transmit signal. In an example, the circulator 16 can be a conventional circulator commercially available and provides at least 30 dB of isolation from the output of the coupler 15 in the transmit path to the input of the receiver mixer 13.

Mixer 13 is also coupled to receiver IF filter 14. The mixer 13 is followed by an analog to digital (A/D) converter 151 coupled to the receiver filter 14. Processing system 24 receives the digital data 30 from an analog to digital (A/D) converter 151. The signal processing system 24 can comprise of a digital signal processing IC, a micro-controller IC, a System on a Chip (SoC) IC, an FPGA or a CPLD. The primary blocks of the signal processing system 24 can be a filter output magnitude calculator/dielectric parameters processing algorithm 16, an EPR (Electron paramagnetic resonance) parameters processing algorithm 17, followed by a material estimator/signal processing algorithm 18 which is coupled to a classification algorithm 19. The Electron paramagnetic resonance signal can be detected by the use of an appropriate magnetic field coil but with the same antenna 2.

The stepped frequency transmitter 10 can also consist of a programmable frequency select control device not shown in FIG. 1 which can be a device commonly known in the art which produces a stepped frequency microwave signal at any one of N stable frequencies as selected by programmable frequency select control device automatically. The stepped frequency transmitter 10 can also consist of programmable frequency select control device not shown in FIG. 1 that allows the transmitter to produce a continuous frequency sweep signal by programming the frequency start and frequency end. In addition, the frequency select control device can also be part of the processing system 24 not shown in the FIG. 1. The frequency select control device can be programmed to sequentially step through the N frequencies, dwelling for a time t_{d} at each frequency. The microwave frequency signals from the frequency transmitter 10 are applied to the coupler 15. The coupler 15 has a controlled leakage whereby a portion of the stepped frequency microwave signal applied at its input is passed on to the antenna 2, through the circulator 16, and radiated toward the material surface 32. The antenna 2 is further arranged to allow the sensing fields from the sensor port 37 comprising of the transmitting signal 389 and receiving signals 399 at the excitation wavelength and to measure any variation in the received signal due to the presence of the material which presents the material surface 32. In the coupler 15 a second portion of the stepped frequency microwave signal transmitted signal is diverted to a delay line length 25 which provides a reference for calibration purposes.

The A/D converter 151 is of a standard type, for example a Tektronics model TKAD10C, and is capable of digitising both real and imaginary parts of a complex input signal. The memory 23 can be a standard high-speed Secure digital (SD) non volatile memory card, for example a Kingston SDXC 512 GB UHS-I recorder, which records data at a rate of 45 Mbits/s or any device that can be used as a memory. The processing system 24 can be a standard parallel computer, a SoC (system on a chip), a micro controller, a FPGA (Field programmable gate array device) or a CPLD (Complex programmable logic device) known in the prior art. The FMCW sensor system 40 has a graphical user interface (GUI) 20 which is displayed on the display device 25 and with which an operator may interact with the system 10 using the touch or any other interface on the display surface. Results generated by the system 10 are also displayed on the display device 25, together with standard information generated by the sensor system such as the material properties. HART unit 21 which is part of processing system 24 is the modem for use in industrial Highway Addressable Remote Transducer (HART) field instruments which is known in prior art for communicating the output from the processing system with the control unit of an industrial unit. Profibus unit 22 which is part of processing system 24 is the modem for use in Profibus (Process Field Bus) as a standard for fieldbus communication in automation technology and which is known in prior art for communicating the output from the processing system with the control unit of an industrial unit.

FIG. 2 (a) shows a block diagram of a combination transmitter, receiver, signal processing system and data classification routine block for the detection of material characteristics mounted on to a horn antenna sensor 5 in accordance with another preferred embodiment of the invention. The horn antenna 5 can be applied in near field or in far field for material detection. The horn antenna sensor 5 is further arranged to allow the sensing fields from the sensor port 37 comprising of the transmitting signal 389 and receiving signals 399 at the excitation wavelength and to measure any variation in the received signal due to the material surface 32. FIG. 2 (b) shows a block diagram of a combination transmitter, receiver, signal processing system and data classification routine block for the detection of material characteristics mounted on to a horn antenna sensor 5 and further integrated to a pipe section in accordance with another preferred embodiment of the invention. The horn antenna sensor 5 can be applied in near field or in far field for material detection. The horn antenna sensor 5 is further arranged to allow the sensing fields from the sensor port 37 comprising of the transmitting signal 389 and receiving signals 399 at the excitation wavelength and to measure any variation in the received signal due the material 33 that flows in the pipe section 39.

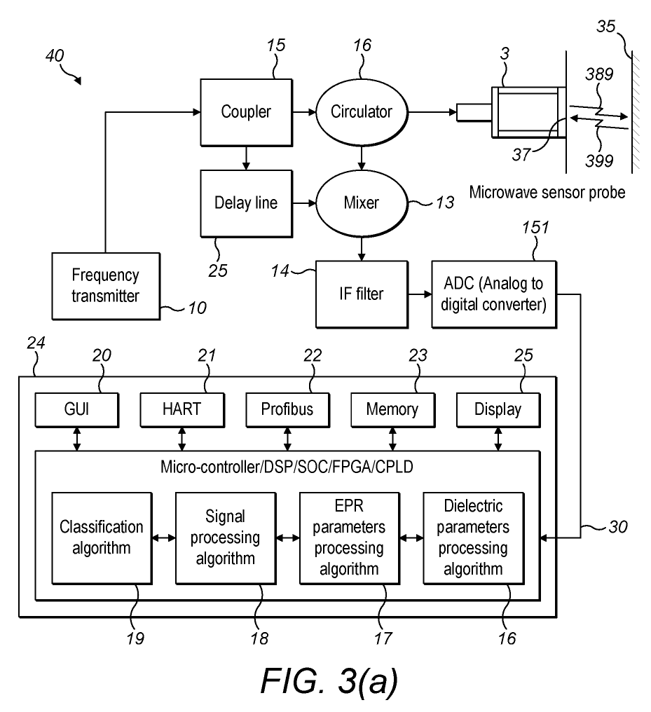

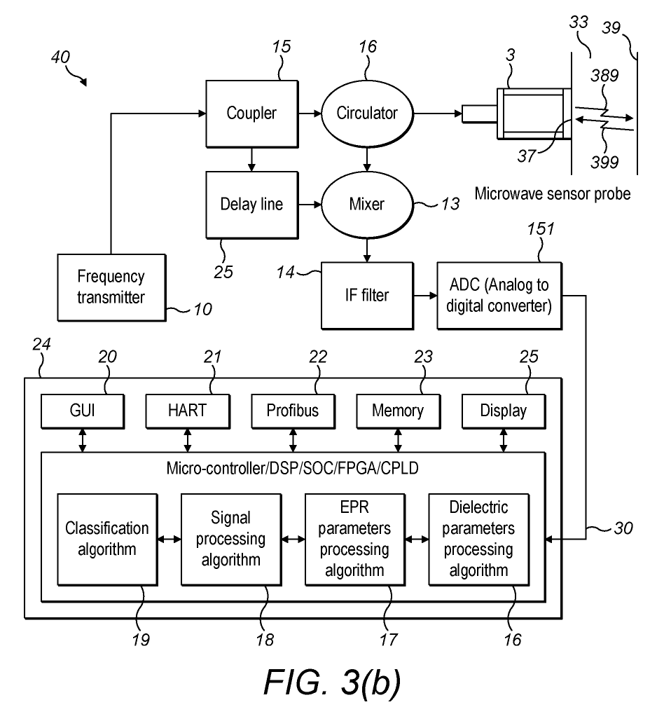

FIG. 3 (a) shows a block diagram of a combination transmitter, receiver, signal processing system and data classification routine block for the detection of material characteristics mounted on the open ended microwave cavity sensor probe 3 in accordance with another preferred embodiment of the invention. The open ended microwave cavity sensor probe 3 can be used in near field or in far field for material detection. The open ended microwave cavity sensor probe 3 is further arranged to allow the sensing fields from the sensor port 37 comprising of the transmitting signal 389 and receiving signals 399 at the excitation wavelength and to measure any variation in the received signal due to the material surface 32. FIG. 3 (b) shows a block diagram of a combination transmitter, receiver, signal processing system and data classification routine block for the detection of material characteristics mounted on to an open ended microwave cavity sensor probe 3 and further integrated to a pipe section in accordance with another preferred embodiment of the invention. The open ended microwave cavity sensor probe 3 can be applied in near field or in far field for material detection. The open ended microwave cavity sensor probe 3 is further arranged to allow the sensing fields from the sensor port 37 comprising of the transmitting signal 389 and receiving signals 399 at the excitation wavelength and to measure any variation in the received signal due the material 33 that flows in the pipe section 39.

FIG. 4 (a) shows a block diagram of a combination transmitter, receiver, signal processing system and data classification routine block for the detection of material characteristics mounted on the high Q microwave cavity sensor 4 in accordance with another preferred embodiment of the invention. The high Q microwave cavity sensor 4 can be used in near field or in far field for material detection. The high Q microwave cavity sensor 4 is further arranged to allow the sensing fields from the sensor port 37 comprising of the transmitting signal 389 and receiving signals 399 at the excitation wavelength and to measure any variation in the received signal due to the material surface 32.

FIG. 4 (b) shows the detailed illustration of the high Q microwave cavity sensor 4 as shown in FIG. 4 (a). This sensor comprises of: a waveguide 401 for guiding the microwave signal; a feed 405; a dielectric reflector 403 at an end of the waveguide to cause formation of a sensing field; and a sample chamber 406, characterised in that: the dielectric reflector has a thickness of at least Δg/20, where Δg is the wavelength of the excited electromagnetic wave in the dielectric reflector, thereby to maximise electromagnetic field intensity in the sample chamber; the dielectric reflector is made of a dielectric material that is different to that of the waveguide; and the waveguide is arranged to allow formation of a standing wave at the excitation wavelength within the dielectric waveguide; and. wherein the dielectric reflector 403 causes formation of a sensing field beyond its outer surface or below its inner surface. Further, the sensor 4 also comprises a concentrator 410 arranged around the dielectric waveguide (401) for concentrating microwave energy in the dielectric waveguide 401 and where in this concentrator is a distributed bragg reflector. The waveguide 401 can in essence be a dielectric filled waveguide or air filled waveguide. The waveguide 401 is separated from the concentrator cavities 409 by concentrator dielectric reflectors 402 of thickness at least Δg/10 to Δg/4 or from Δg/10 to Δg.

A number of different structures can be implemented. For example, the concentrator cavities 409 can be arranged in a honey comb fashion with the waveguide 401 taken up by the λ/2 resonator where λ is the wavelength of the excited wave in the waveguide 401. The waveguide 401, concentrator 410 and the dielectric reflector 403 are in a hollow metallic housing 404. In use, the sample 408 can be introduced into the sample chamber 406. The sample chamber 406 can also be part of the pipe section 33 sensing the material 33 under flow as shown in FIG. 4 (c). FIG. 4 (c) shows a block diagram of a combination transmitter, receiver, signal processing system and data classification routine block for the detection of material characteristics mounted on to the high Q microwave cavity sensor 4 and further integrated to a pipe section in accordance with another preferred embodiment of the invention. The high Q microwave cavity sensor 4 can be applied in near field or in far field for material detection. The high Q microwave cavity sensor 4 is further arranged to allow the sensing fields from the sensor port 37 comprising of the transmitting signal 389 and receiving signals 399 at the excitation wavelength and to measure any variation in the received signal due the material 33 that flows in the pipe section 39.

In FIG. 1, 2, 3, 4 (which will be described in the following), the measuring apparatus comprises a transmitter, receiver, processor and data formatting assembly can be mounted to an antenna 2 in free space as shown in FIG. 1, 2 (a), 3 (a), 4 (a) or in an existing port or sensor port 37 on a pipe section as shown in FIGS. 2 (b), 3 (b) and 4(c). The sensor port 37 can be approximately 0.5 to 40 centimetres (cm) in diameter. A pressure window of glass, ceramic, plexiglass or other structural material, which are transparent to microwaves can be affixed to the port 37 in such a way as to provide a tight seal. A microwave sensor 3 can then be mounted to the window such that the microwave beam from the sensor is directed towards the target material in the pipe section 33 on which measurements are to be made. The FMCW sensor system 40, which contains the frequency transmitter, receiver and processor electronics, can be mounted directly behind the antenna 2 in FIG. 1 or sensor 3 in FIG. 3 in a compact housing.

It is to be noted that the antennas that can also be named as the microwave sensor probes 2, 5, 3, 4 shown in FIG. 1, 2, 3, 4 respectively can be connected to the transmit/receive electronics of the material characteristic measurement device via a feed network of microwave splitters, which are known in the art or by a simple SMA feed connector. Thus while the preferred embodiment is an open ended microwave cavity 3, it is not required that the sensor probe be an open ended microwave cavity. Various other antenna configurations are readily adaptable; as such a high Q microwave cavity, planar microwave array, a horn antenna could be used.

The microwave sensor probes 2,3,4,5 can be operated in the near field and far field modes. In the near field mode, a very high Q factor standing wave pattern is required. For example, for near field operation a Q factor more than ten and ideally more than twenty is preferred. When this occurs there is no intrinsic wave impedance match with the surroundings (air). Instead the microwave sensor probes are operated below a cut-off frequency when compared to the resonant frequency of the waveguide, for example in TM mode, thereby producing an evanescent wave constituting a near field within the waveguide 3. The microwave sensor probes 2,3,4,5 can be represented as being operated in the microwave cavity mode in the near field mode. When the FMCW sensor system 40 is operated in this mode, the magnitude of the reflected signal, the shift in frequency due to perturbation of microwave cavity due to the interaction of fields with the material of interest, the change in effective Q factor of the microwave cavity due to the interaction of fields with the material of interest can be measured. In this situation a sample is introduced into the evanescent wave region.

In the far field mode, the field of the excitation wavelength radiates beyond the dielectric reflector surface, as the microwave sensor probes operated above a cut-off frequency. In this case the sample is at a distance that can range between 0.1 mm to 100 cm from the microwave sensor probes. When the FMCW sensor system 40 is operated in the far field mode reflected signal parameters, such as the backscattering (diffuse reflection), specular reflection of the first continuous wave microwave signal, the time difference between the first continuous wave microwave signal and the second continuous wave microwave signal and the magnitude of the backscattered or specular reflection of the first continuous wave microwave signal can be measured.

In addition to the components of the FMCW sensor system 40 outlined above, it may be desirable to combine other functionality with the FMCW sensor system 40, such as the provision of a temperature measurement module to measure the temperature of the material of interest. If the FMCW sensor system 40 further comprises a temperature module, this is preferably an immersion type temperature module.

FIG. 5 shows a detailed schematic of an open-ended microwave cavity sensor 3 as represented in FIG. 2 that can be interfaced to a flow pipe 39. The open ended microwave cavity sensor 3 is an open ended cavity that comprises of a waveguide 8 that can either be filled with a dielectric or dielectric material or air for guiding the microwave signal and that creates a resonance to allow formation of a standing wave at the excitation wavelength within the waveguide; a feed 7; a metallic waveguide wall 9 to contain the electromagnetic fields and a dielectric reflector 101 at an end of the dielectric waveguide to cause formation of a sensing field by increasing the intensity of the electromagnetic fields beyond its outer surface or below its inner surface; and wherein the electromagnetic fields extends beyond the dielectric where in the dielectric reflector 101 has a thickness of at least Δg/20, where Δg is the wavelength of the excited electromagnetic wave in the dielectric reflector, wherein the dielectric reflector is made of a dielectric material that is different to that of the waveguide and the dielectric reflector 101 causes formation of a sensing field beyond its outer surface or below its inner surface. The open-ended microwave cavity sensor 3 is further arranged to allow the sensing fields comprising of the transmitting signal 389 and receiving signals 399 at the excitation wavelength and to measure any variation in the received signal due to the material in the pipe 398. It is to be observed that the construction or geometry of the open ended microwave cavity sensor should not be construed as limited to the one shown FIG. 1 but they may be implemented with any of circular geometries for the waveguide 8, dielectric reflector 8 but also with a Bragg resonator based concentrator around the waveguide 8 after removing the metallic waveguide wall 9 as disclosed in WO 2013164627 A1.

Further the sensor 3 can be operate in a near field mode where in the sensor has a resonance with high Q factor above 50 or in a far field mode wherein the sensor has a resonance with moderate Q between 1 and 50. The dielectric reflector 101 can be of any microwave permeable material such as ceramic, glass, plastic that can be machined to fit the pipe assembly section 39.

FIG. 6 shows a simple schematic of an open-ended microwave cavity sensor 3 as in FIG. 1 for detecting a surface or a solid material 397 and to monitor any change of the received signal due to the material 397. The solid material can further be a sheet of metal, polymer, ceramic and can further be any dielectric material.

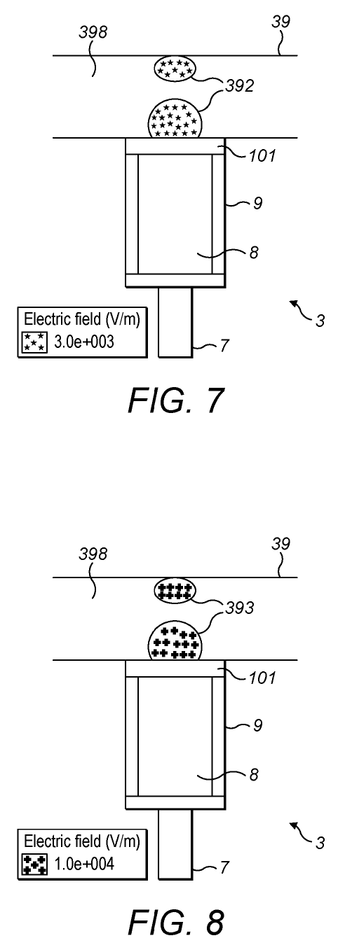

FIG. 7 shows a standing wave electric field distribution 392 in the open ended microwave cavity sensor without the dielectric reflector 101. For comparison, the electric field distribution 392 in the pipe section 39 without the dielectric reflector can be as low as 3.0e+003 V/m.

FIG. 8 shows an electric field distribution in the open ended microwave cavity sensor showing the effect of the dielectric reflector 101. The electric field distribution 393 in the pipe section 39 with the dielectric reflector 101 can be 1.0e+004 V/m.

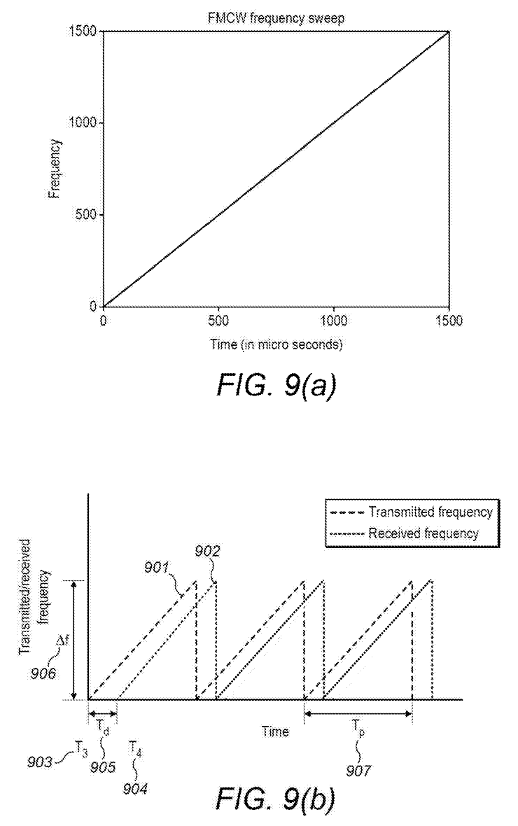

The frequency transmitter 10 as shown in FIG. 1 outputs an intermediate modulated continuous wave signal and its beat frequency f_{b} can be approximated by

$${f}_{b} = \frac{Δ f}{{T}_{p}} {T}_{d} \qquad ( 1 )$$

Where Δ is the frequency sweep bandwidth (say 906 as in FIG. 9(b)) of the FMCW transmitter 10 and Tₚ (say 907 as in FIG. 9(b)) is the frequency sweep time interval. If a sample is placed at a distance ‘d’ away from the sensor port 37 (as in FIG. 3) then the time difference T_{d} (say 905 as in FIG. 9(b)), the difference of T₄ (904)−T₃ (903) between the transmitted 901 and reflected 902 frequency modulated continuous wave microwave signals is:

$${T}_{d} = \frac{2 R}{c} + {t}_{d} \qquad ( 2 )$$

Where t_{d} is the dwell time of the transmitted signal on the material of interest. In any practical system, the frequency cannot be continuously changed in one direction; hence only periodicity in the modulation is necessary. Frequency modulation includes triangular waveforms, saw tooth waveforms, sinusoidal waveforms, square waveforms and other suitable waveforms. The first frequency modulated continuous wave microwave signal through the coupler 15 which is the emitted signal from the microwave sensor and the second frequency modulated continuous wave microwave signal through the circulator 16 which is the reflected signal from the target or material of interest are multiplied in a mixer 13. The high frequency term is filtered out using a low-pass filter and a beat frequency f_{b} is obtained given by

$${f}_{b} = \frac{Δ f}{{T}_{p}} \frac{2 R}{c} \qquad ( 3 )$$

The reflected signal is of exactly the same frequency as the transmitted frequency signal, but differs in phase by an amount which is also directly proportional to the distance from the sensor to the material of interest. If the microwave frequency signal has a frequency fₙ, the distance to be measured is R, and the velocity of electromagnetic; microwave signal is c (the speed of light), then the phase difference in radians between the direct microwave frequency signal and the reflected signal is given by:

$${β}_{n} = ( \frac{{f}_{n} R}{c} + \frac{2 Δ fR}{{T}_{d}^{2} c} {T}_{p} ) π \qquad ( 4 )$$

(from Skolnik, M. Radar Handbook, 2nd Edition, McGraw Hill, 1990, page 3.36). A low pass filter following the mixer 13, as in FIG. 1, removes all but the cos(βₙ) phase term as defined above. The output of receiver filter/amplifier 14, at a transmitted frequency fₙ, is proportional to cos(β). For a given distance R to the target, the output of the filter/amplifier 14 will represent a unique sampled sinusoidal waveform, which is proportional to the effective distance R as well as the dielectric properties of the materials of interest.

At each frequency, the microwave frequency transmitted signal has a dwell time t_{d}, which is proportional to the effective dielectric properties of the materials of interest. Thus the effective low pass filtered signal considering the effective dielectric properties of materials of interest after the mixer (during an observation time) depends on two frequencies, the beat frequency and the difference between frequency sweep bandwidth and beat frequency, Δf−f_{b}.

The mixed signal and its phase function can be approximately defined for the FMCW system that has the sweep bandwidth equal to the ideal sensor frequency bandwidth and further say with a Q factor of 0.01 as

$${S}_{if} = A \cdot exp [ j 2 π ( \frac{2 NR}{c} {nT}_{d} + \frac{2 Δ fR}{{T}_{d} c} {T}_{p} ) ] \qquad ( 5 )$$

Where A is the amplification and N is the number of frequency sweeps or periods per second.

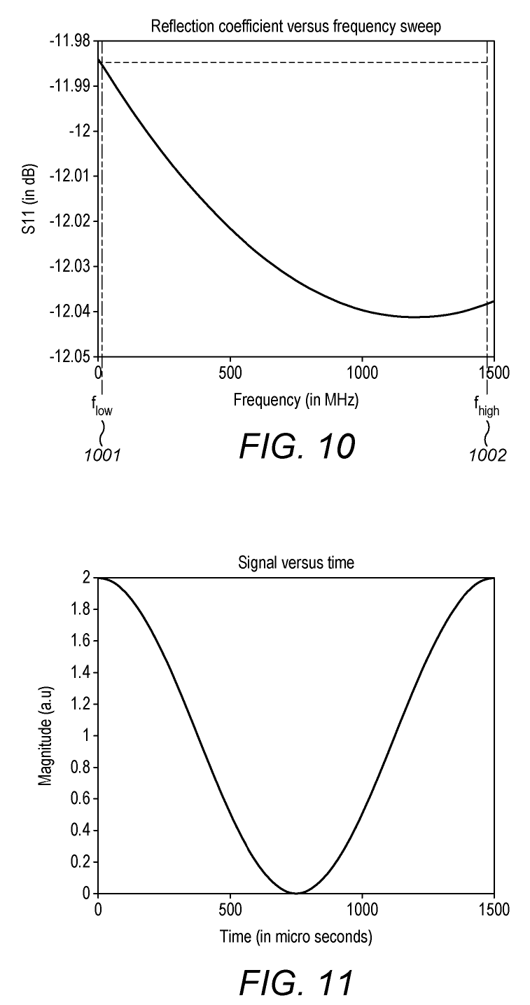

The mixed signal and its phase function can be approximately defined for the FMCW system that has the frequency sweep bandwidth (say 906 as in FIG. 9(b)) of the FMCW transmitter 10 not equal to the sensor bandwidth defined by fhigh(1002)−flow (1001) as in FIG. 10 or defined by f_{high}(1302)−f_{low}(1301) as in FIG. 13 or defined by or defined by f_{high}(1502)−f_{low}(1501) as in FIG. 15 as:

S_{if 2}=S_{if}*Γᵢₙ(fₐₙₜ) (6)

Where Γᵢₙ(fₐₙₜ) is the reflection coefficient of the sensor 2 (can also be a microwave cavity sensor or a horn antenna). In order to derive the reflection coefficient for example for the sensor

5 in FIG. 2 or for sensor 3 in FIG. 3 or for sensor 4 in FIG. 4 with possible varied sensor bandwidth one can represent the sensor as a one-port model using a parallel resonant circuit representing the cavity mode. The coupling loop for the for the sensor 5 in FIG. 2 is modeled as a series inductive reactance Xₛ, assumed constant over the bandwidth of the frequency response of the cavity (legitimate for high Q cavities). The resonant circuit impedance and the cavity parameters Q₀ and f₀ (unloaded Q and resonant frequency) are represented by the parallel capacitor-inductor combination. From the circuit model, the unloaded input impedance is given by:

$${Z}_{in} ( {f}_{ant} ) = j {X}_{s} + {{R}_{0} [ 1 + j 2 {Q}_{0} ( \frac{f - {f}_{0}}{{f}_{0}} ) ]}^{- 1} \qquad ( 7 )$$

The equation above is an approximation to the input impedance that could be measured by a network analyser with a calibration plane at the input of the antenna 2. The combined loading effect of the loop reactance and the external circuit on the cavity mode can be analysed by calculating the reflection coefficient. This reflection coefficient is given by:

$${Γ}_{in} ( {f}_{ant} ) = {Γ}_{d} [ 1 - \frac{2 κ}{1 + κ} \cdot \frac{1}{1 + j 2 {Q}_{L} ( \frac{f - {f}_{0}}{{f}_{0}} )} ] \qquad ( 8 )$$

Where the coupling coefficient K is

$$κ = ( \frac{{R}_{0} / {Z}_{0}}{1 + {( {R}_{0} / {Z}_{0} )}^{2}} ) \qquad ( 9 )$$

The constant Γ_{d}, defined as the detuned reflection coefficient, is the asymptotic value of Γᵢₙ for frequencies far from the resonant frequency f₀, such that:

$${Γ}_{d} = ( \frac{j {X}_{s} - {Z}_{0}}{j {X}_{s} + {Z}_{0}} ) \qquad ( 10 )$$

The Q loaded and the frequency response f_{L} are given by

$$\begin{matrix}{Q}_{L} = \frac{{Q}_{0}}{1 + κ} & ( 11 ) \\ {f}_{L} = {f}_{0} ( 1 + \frac{κ {X}_{s}}{2 {Q}_{0} {Z}_{0}} ) & ( 12 )\end{matrix}$$

In order to obtain a matched condition at resonance when the cavity's input impedance equals the characteristic impedance of the waveguide means that one would require R₀=Z₀ and Xₛ→0. Applying these conditions to the cavity when loaded by an external circuit, we have:

Xₛ^{lim→0}κ|R₀=Z₀=1

and

Xₛ^{lim→0}f_{L}|R₀=Z₀=f₀

Thus the resonant frequency measured at the input port will closely approximate. By the substitution of κ, f_{L}, Q_{L}, Γ_{d} in Γₙ(fₐₙₜ), one could formulate the reflection coefficient of the sensor and one could easily evaluate the mixer output of the FMCW system with the sensor for example for the sensor 5 in FIG. 2 or for sensor 3 in FIG. 3 or for sensor 4 in FIG. 4 by the multiplication of this reflection coefficient with the IF signal output after IF filter 14 of the FMCW system.

FIG. 9 (a) shows the schematic showing the frequency sweep from the FMCW frequency transmitter 10. The frequency sweep shown is normalized and the sweep is from 1 MHz to 1500 MHz. For the sake of illustration the actual CW (Continuous wave) frequency of transmitter 10 as in FIG. 1 can be 9 GHz where as the frequency sweep is from 9 GHz to 10.5 GHz in steps of 1 MHz. The time taken to sweep this frequency sweep is 1500 μsec that corresponds to 1 μsec for 1 MHz step in frequency for the actual sweep of the transmitter 10 from 9 GHz to 10.5 GHz. The transmitted signal 389 and received signal 399 shown in FIG. 5 at the excitation wavelength have the same frequency. Due to the fact that the frequency transmitter 10 as in FIG. 1 continuously sweeps the frequency in time and by the time the signal is received at mixer 13 as in FIG. 1 after reflection; the frequency of the transmitting signal will be different and the mixer thus produces an IF signal that is sinusoidal.

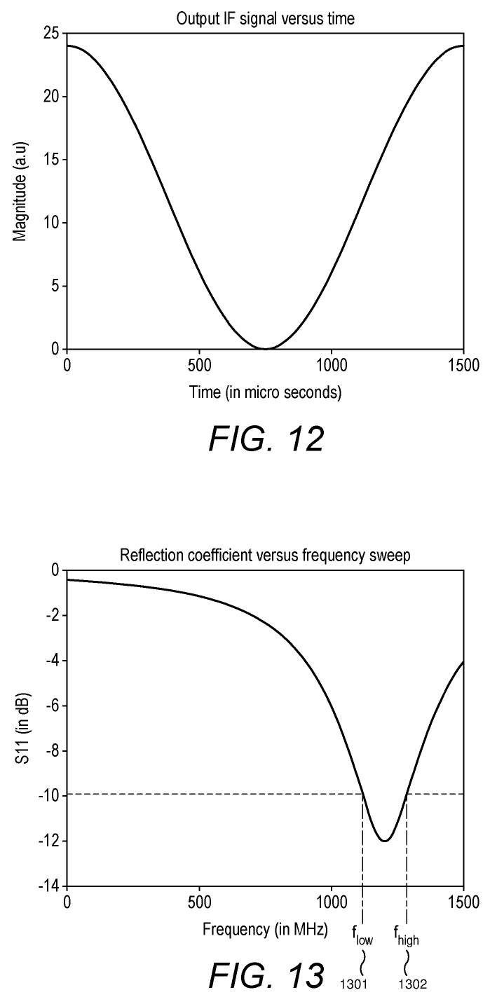

In this embodiment, further, this sinusoidal IF signal is obtained for a full sweep of the transmitting frequency 10 and only if the sensor frequency bandwidth defined by the −10 dB bandwidth of the reflection coefficient further defined by f_{high}(1002)−f_{low}(1001) as in FIG. 10, is at least equal to the frequency sweep bandwidth of the transmitting frequency 10. The horn antenna or sensor 5 that has the sensor bandwidth equal to the frequency sweep bandwidth (say 906 in FIG. 9(b)) and which is interfaced with the FMCW sensor system 40 is as shown in FIG. 2. FIG. 10 shows the schematic of the reflection coefficient of a reference antenna (horn antenna 5) with respect to the normalized frequency sweep of the FMCW frequency transmitter 10. As outlined above the horn antenna or sensor 5 can be applicable in near field or in the far field for material detection. Thus for this horn sensor 5, if the normalized sensor bandwidth is 1.5 GHz as shown in FIG. 10 and the normalized frequency sweep is again 1.5 GHz then a sinusoidal IF out put as obtained. FIG. 11 shows the sinusoidal schematic of the ideal mixer 13 IF output in time domain of the FMCW sensor interfaced to a reference antenna (horn antenna with Q=0.01) for the horn sensor 5. FIG. 12 shows the IF output in time domain of the FMCW sensor interfaced with the horn antenna 5 with Q=0.5 and after the mixer 13 and IF filter 14.

The IF signal that is obtained for a full sweep of the transmitting frequency 10 as for example obtained by way of the apparatus shown in FIG. 3 will not be sinusoidal if the sensor 3 bandwidth defined by the −10 dB bandwidth of the reflection coefficient which is further defined by f_{high}(1302)−f_{low} (1301) as in FIG. 13, is not equal to the frequency sweep bandwidth (906 in FIG. 9(b)) of the transmitting frequency 10 (as in FIG. 3). FIG. 13 shows the reflection coefficient of a single mode open ended microwave resonant cavity sensor 3 as shown in FIG. 3 with Q=50 and further normalized with respect to the sweep frequency 10 as shown in FIG. 9(a). In this embodiment of the present invention, If the FMCW sensor system 40 is interfaced with open ended microwave resonant cavity 3 similar to the scheme as shown in FIG. 3 with Q=50; and further due to the interaction of the transmitted signal 389 from FMCW frequency transmitter 10, with the received signal 399 at the mixer 13 an IF output is obtained from the reflected signal from the resonant cavity that can generally be estimated with Equation 6 which is a factor of the multiplication of the sinusoidal IF signal obtained with an ideal antenna of Q factor 0.01 as shown in FIG. 11; and with the reflection coefficient of a open ended microwave resonant cavity sensor 3 as for example shown in FIG. 13. Further, this IF signal curve is arbitrary and not sinusoidal and which is further dependent on the reflection coefficient of the sensor 3 with respect to the normalized sweep frequency.

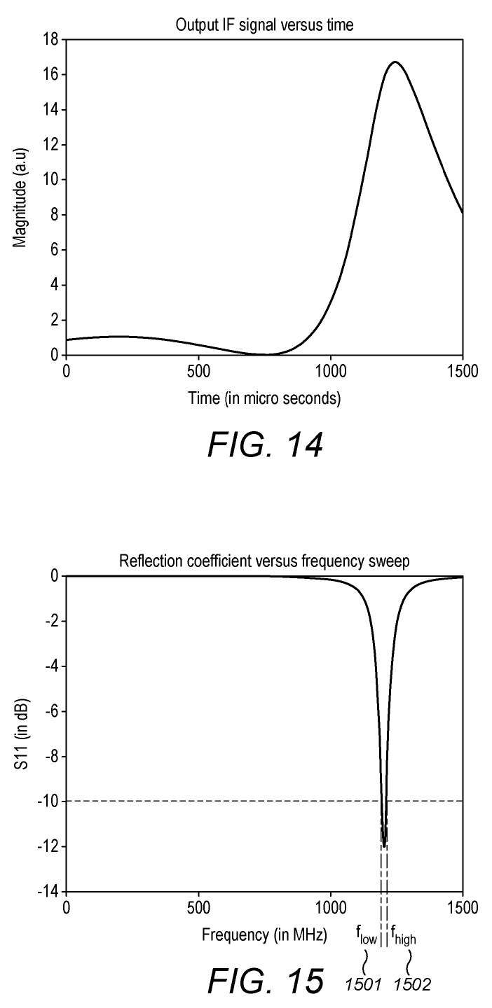

FIG. 14 shows the IF output in time domain of the FMCW sensor interfaced with the open-ended microwave resonant cavity 3 with Q=50 and after the mixer 13 and IF filter 14. Further, in this embodiment of the present invention, for applications that would require inspection of materials that would flow in pipelines, it is ideal to measure the magnitude of the backscattered or specular reflection of the microwave signal along with the frequency perturbation and change in Q factor from the IF signal obtained as in FIG. 14. The IF signal can further be in the form of sinc waveform or even an impulse or in any other arbitrary form depending on the sensor bandwidth and reflection coefficient of sensor 3.

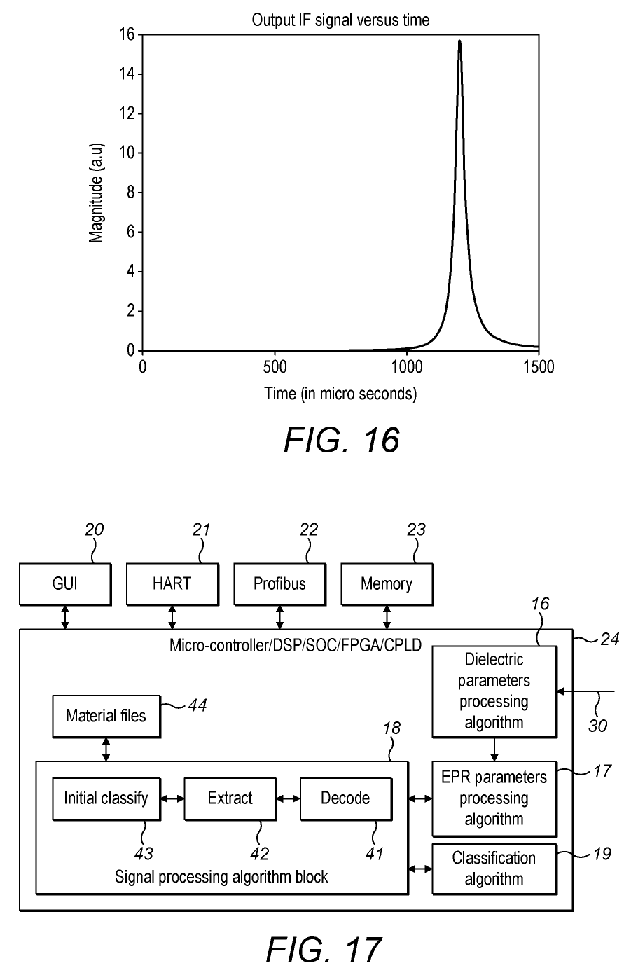

Further, in yet another embodiment of the present invention, the IF signal that is obtained for a full sweep of the transmitting frequency 10 as for example in FIG. 4 can further be in the form of sinc waveform or as an impulse or in any other arbitrary form if the resonant bandwidth of the sensor 4 defined by the −10 dB bandwidth which is further defined by f_{high}(1502)−f_{low}(1501) as in FIG. 15, of the reflection coefficient is not equal to the frequency sweep bandwidth (say 906 in FIG. 9(b)) of the transmitting frequency 10. FIG. 15 shows the reflection coefficient of a single mode with high Q open ended microwave resonant cavity 4 as shown in FIG. 4 with Q=500 with respect to the normalized frequency sweep 10. If the FMCW sensor system 40 is interfaced with open ended microwave resonant cavity 3 as shown in FIG. 4 with Q=500, due to the interaction of the transmitted signal from FMCW frequency transmitter 10, with the received signal at the mixer 13 an IF output is obtained from the reflected signal from the resonant cavity that can generally be estimated with Equation 6 which is a factor of the multiplication of the sinusoidal IF signal obtained with an ideal antenna of Q factor 0.01 as shown in FIG. 11; and with the reflection coefficient of an open ended microwave resonant cavity sensor 4 as for example shown in FIG. 13. obtained from the reflected signal from the high Q resonant cavity. FIG. 16 shows the IF output in time domain of the FMCW sensor interfaced with the open-ended microwave resonant cavity 4 in FIG. 4 with Q=500 and after the mixer 13 and IF filter 14.

FIG. 17 shows a block diagram illustrating the detailed blocks in the microcontroller/FPGA/CPLD processing system 24 as in FIG. 1, 2, 3, 4 in order to implement the routines for data gathering, training and classifying the material of interest. In the preferred embodiment of the present invention there is a method for effectively determining the physical parameters of materials under test or interest from the IF signal S_{f2} as in Equation (6) after passing through the band pass filter 14 by the use of appropriate dielectric parameters extraction algorithm 16, Signal processing algorithm block 18 and the classifications algorithms 19. The signal processing algorithm block 18 further consists of the decode block 41 for the dielectric and EPR parameters, the extract 42 block for extracting these parameters and further an initial classify 43 block for the initial classification. The signal processing algorithm block 18 further saves the output data after processing in material files 44 and also retrieves the output data from the material files 44 when necessary. Further, the material files 44 can also be part of the memory 23. The method thus further includes processing the received stepped frequency microwave signal to determine the material properties of interest. It may involve processing FMCW based sensor returns in the form of IF signal S_{f2} to obtain a sequence of spectra for each material of interest and producing a sequence of feature vectors. Modelling may be performed to identify the sequence of feature vectors that indicate as a member of a particular class of materials.

A training sequence is necessary in order to calculate the probability distribution for classification in real time. One could perform the training sequence in real time or on a computer offline.

A preliminary training procedure in which parameters for the states or probability distributions and transition probabilities are produced by deriving feature vectors for training data obtained from known classes of material and calculating the mean and variance of vectors corresponding to like material classes. The classification training procedure may include a plurality of cycles through state sequences.

The main steps in that are present are:
Acquiring the exemplar data. The exemplar data can be given a name followed by a time stamp using the appropriate selection menus.
Plotting any user defined raw data.
Training the system with the exemplar data.

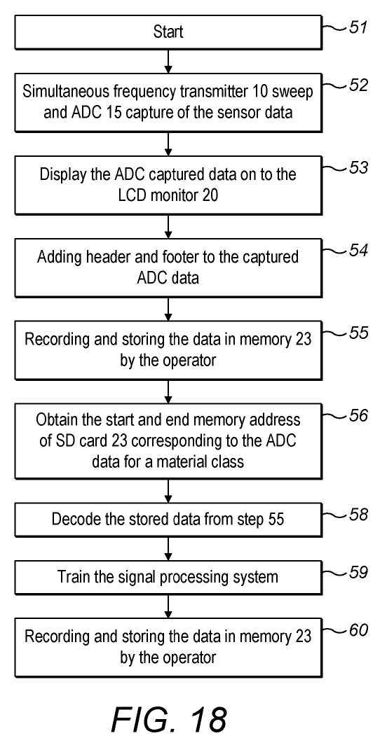

FIG. 18 shows a flow diagram illustrating the series of routines to be executed by the processing system 24 as in FIG. 1, 2, 3, 4 to acquire data from the FMCW based sensor and train the system.

The processing system 24 is first used to gather training data 52 corresponding to FMCW based sensor returns from a set of exemplar material into which the processing system 24 is required to classify unknown materials in practice based on the exemplar material information. In the present embodiment, the target groups which include but are not limited to food products, Juice drink products, Fizzy drink product, Beverages, multiphase crude oil, etc. The classification can be based on the amount of water estimation in the above products or the amount any other constituent in the products. Members of a set of exemplar materials are brought serially into sensing region of the sensors 2, 3, 4 and 5. The materials flow or the materials be present in front of the sensors 2, 3, 4 and 5. At least ten different compositions of an example material class are used to train the processing system 24. Training data gathered by the processing system 24 for a particular material group such as fizzy drinks can include data from just one example material class within that group. For example, for the target group “sweetened frizzy drink”, training data may be gathered from a sugar free fizzy drink. However, in use, the processing system 24 is able to recognise and classify any fizzy drink including all kinds of sugar and sugar free fizzy drinks.

The FMCW based sensor is switched on and starts sweeping the frequency at a rate of at least 100 Hz sweep repetition frequency. Once the record mode has been enabled, for each frequency step that is transmitted the FMCW based sensor system 40 captures data after ADC 151 for at least 1500 frequency steps which are digitised by the A-to-D converter 151 and stored serially on to the memory 23. An operator monitors 53 the received FMCW based sensor echo on display device 20.

One frequency sweep of the FMCW based sensor generates at least 1500 complex values that are stored as a continuous data block on the memory 23 which is sandwiched between a header block and a footer block. The 1500 weighted digital samples gathered from one frequency stepping sequence will, for the purposes of this description of the preferred embodiment, be referred to as one data record. The data for the header block and footer block 54 is generated and contain information regarding the FMCW based sensor operating mode set up, the time stamp from the FMCW sensor system 40 which are useful for post processing purposes. The recording mode is enabled during the training mode of the processing system 24. In the recording mode the exemplar material information such as the material class name is also added by the operator to the header and footer block 54. This information is required in order to form a material file 44.

A naming convention is assigned to represent target group of materials and the numbering convention would uniquely identify each material file from a particular class that correspond to different concentrations or combinations in a material group. The numbers are not repeated for the sequence of spectra of material files belonging to a particular class: they may however be reused when naming material files that belong to separate material groups. Since each target file 44 also contains a 2 dimensional matrix in which each row is an independent IF signal S_{if2} frame consisting of at least 1500 data points, the entire file therefore represents a sequence of IF signal S_{if2} frames from the examplar material target.

Further each material file group 44 consists of a series of at least 500 material frames (they are the rows of the 2-dimensional matrix) corresponding to each material class and as outlined above each material frame is at least 1500 element vector. However, the elements in the material frame are not independent and the size of the material frame vector can potentially be reduced without loss of information.

Data for a total of about 500 frequency sweeps for each material class is recorded 55 after which the recording mode is disabled. The memory device 23 sends memory addresses for the start and end of the recording sequence to the processing system 24 via the communication line. The operator takes a manual record 57 of the start and end memory addresses and also notes the material type and the concentrations in the material type.

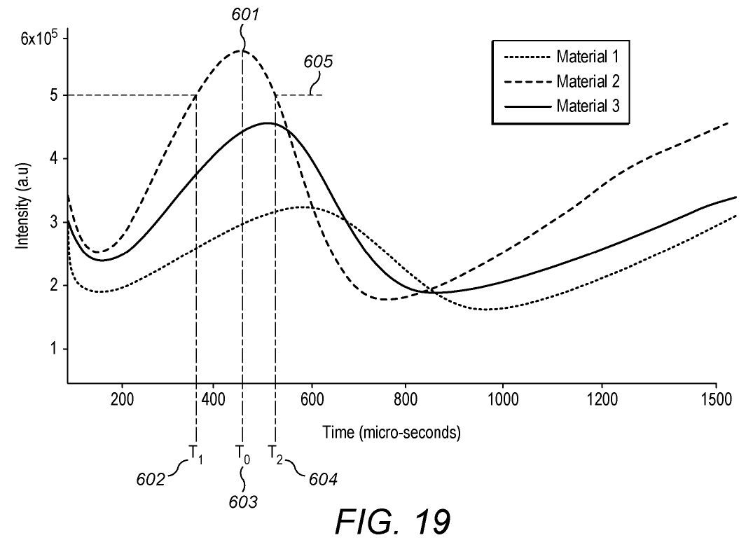

FIG. 19 shows the raw IF signal data illustration in time domain after the ADC 151 due to response of the FMCW sensor system 40 for a three different materials with a microwave cavity sensor 3. Parameters such as the magnitude, the equivalent resonant frequency and Q factor equivalent values can be obtained from the plot shown in the FIG. 19. Since the raw IF signal in time domain is also a factor of the resonant Q factor of the sensor 3, the equivalent values can be defined as follows. The magnitude of the raw IF signal is the value of the peak amplitude 601, the equivalent resonant frequency is 1/(T₀(603)). The shift in resonant frequency is thus proportional to the shift in T0. The equivalent Q factor is given by:

$${Q}_{equi} = \frac{1 / {T}_{0}}{1 / {T}_{1} - 1 / {T}_{2}} \qquad ( 13 )$$

Where T₀(603), T₁ (602), T₂ (604) correspond to the time at which the magnitude is peak magnitude minus a constant value which can be for example 1×10⁵. It is to be observed that the value can vary from material to material and can be as low as 10 and as high as 1×10¹⁰

A training algorithm sequence as outlined above is needed to be implemented in order to distinguish different classes of material concentrations for example. Similar analysis can be implemented on variations of density, volume, humidity, moisture content, porosity, permeability, size, mass, surface roughness, surface position, absolute position, distance, or a combination thereof.

Once the data is recorded, the training sequence is implemented. By using keyboard the operator enters the address for the first material raw data. The decode routine strips of the header and footer information and places the 1500 complex values into a data matrix. The decode operation is performed for all the 500 sweeps that were recorded on to the memory 23 during data capture for each material class of interest. The output after the decode routine is a 3-dimensional matrix that has at least 10 rows corresponding to each material group followed by 500 rows for each material class and with each row containing 1500 columns. Each row from a material class represents FMCW based sensor data received from individual frequency sweep and each column represents data from individual frequency step. Therefore, for example element (2, 10, 1200) will be the FMCW based sensor data derived for the material group from the 10th sweep at the 1200th frequency step. The processing system 24 sends an instruction to the memory 23 via the communication link to read the data at the entered address and process it through a series of routines for training 59 which run on the processing system 24 for the materials groups and classes. Conditional probability values are assigned to the known class of materials with respect to the frequency sweep steps of the received FMCW based sensor IF data. Once the training is complete the training output files are stored in the memory 23.

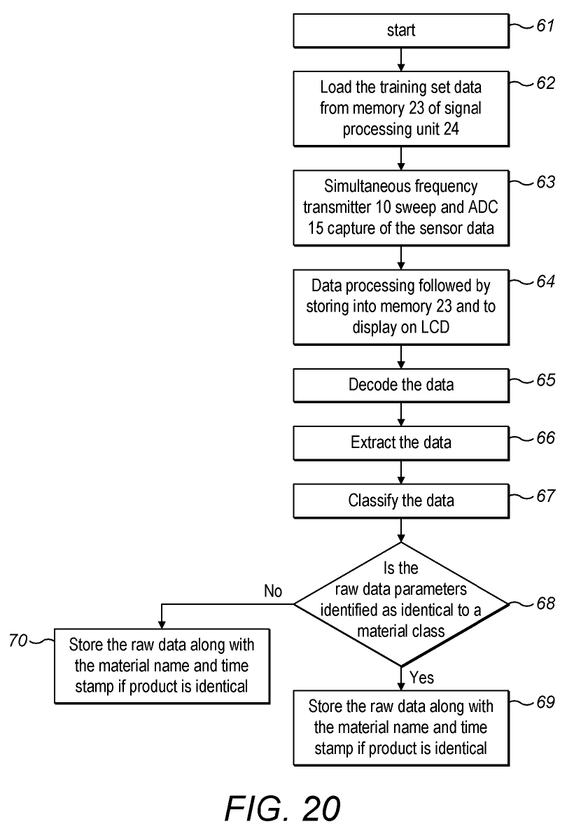

FIG. 20 shows a flow diagram illustrating the series of routines to be executed by the processing system 24 as in FIG. 1, 2, 3, 4 to acquire data from the FMCW based sensor, to process the acquired data and classify the data for material identification. Once the processing system 24 is trained for a number of materials of interest, the processing system 24 is ready for classifying the new raw data from unknown material classes and material groups. The classification is performed in real time mode with the processing system 24 where, in both data, capture from unknown materials and classification are implemented simultaneously in real time. The process starts with loading the training set data 62 from memory 23 of signal processing system 24 followed by processing system 24 gathering the raw IF data 63 corresponding to FMCW based sensors 2, 3, 4, 5 returns from an unknown material into which the processing system 24 is required to classify unknown materials in practice based on the exemplar material information. The data for the header block and footer block 54 is generated and contains information regarding the FMCW based sensor time stamp from the FMCW sensor system 40. Data for a total of at least 10 frequency sweeps for is recorded 64 after which the recording mode is disabled. The processing system 24 then decodes 65 the raw IF data by arranging the data in a known sequence in the signal processing system 24 followed by extracting 66 the training data into the processing system. The signal processing system 24 then classifies 67 the raw IF data by applying the conditional probabilities depending on the exemplar training data followed by checking if the raw data parameters are identical to that of the parameters of a material class 68.

Statistical variables are estimated for all of the material class exemplars using the Bayes' rule from the 1500 weighted digital samples from a frequency sweep. These variables are applied to classify and to compute the probability for a certain set to be an observation of a class of material or product for example a dairy cream material or product.

Estimating methods like Bayes estimator, Maximum Likelihood Estimate (MLE) and Maximum a Posteriori (MAP) estimate routines can be used in order to classify in the processing system 24. If the likelihood probability is above a certain threshold with respect to any of the material class or groups then the raw IF data, the time stamp along with material group name and class name are stored 69 in the memory 23. If the likelihood probability is below a certain threshold with respect to any of the material class or groups then the raw IF data along with the time stamp are stored 70 in the memory 23

Thus, an apparatus and method has been described which overcomes specific problems and accomplishes certain advantages relative to prior art methods and mechanisms. The improvements over known technology are significant. The method and device described herein provide an FMCW based sensor implementation with an improvised sensor probes whereby the material properties can be determined. A single receive path is used, with one microwave mixer, one receiver amplifier, and one ADC converter. By using a narrow bandwidth sweeping filter, the sampling rate may be greatly reduced, further reducing power and allowing for higher resolution ADCs to be used. The method and apparatus use all digital processing after the IF filter to minimize contributions to the measurement error. In addition, the method and apparatus use special digital processing algorithms to identify materials of interest in a novel way and further improve reliability.

While the invention has been described in conjunction with a specific embodiment, many alternatives, modifications, and variations will be apparent to those of ordinary skill in the art in light of the foregoing description. Accordingly, the invention is intended to embrace all such alternatives, modifications, and variations as fall within the spirit and broad scope of the appended claims.

1. A materials characteristic sensor system, comprising:
a sensor comprising a waveguide: and
a transceiver for transmitting a continuous wave signal to be incident on a material to be characterised,
wherein the sensor is operable to receive a reflected continuous wave signal reflected from the material, and wherein a characteristic of the material is determined using at least one of a resonance frequency difference, a magnitude difference, or a Q factor difference due to the material interacting with the transmitted continuous wave signal.

2. A materials characteristic sensor system as claimed in claim 1, wherein the transceiver is arranged to:
combine the continuous wave signal and the reflected continuous wave signal; and
analyse the resulting beat frequency signal (or IF signal) to determine the characteristic of the material.

3. A materials characteristic sensor system as claimed in claim 2, wherein the transceiver is arranged to:
sample the beat frequency signal (or IF signal) by digitising an analogue measurement curve based on the reflected continuous wave signal; and
using at least one characteristic of the sampled beat frequency signal (or IF signal) to determine the characteristic of the material.

4. A materials characteristic sensor system as claimed in claim 2, wherein the transceiver comprises a mixer and the transceiver is arranged to obtain the beat frequency or the sampled IF signal after the mixer by:
incrementing a frequency of the continuous wave signal in a plurality of steps for the entirety of a sweep range of the continuous wave signal;
digitising a resultant IF signal obtained after the mixer; and
sampling the resultant IF signal at an analogue to digital converter (ADC).

5. A materials characteristic sensor system as claimed in claim 1, wherein the transceiver is arranged to analyse a resulting peak magnitude, and/or an equivalent resonant frequency and/or a Q factor equivalent of the resulting IF signal to determine the characteristic of the material.

6. A materials characteristic sensor system as claimed in claim 1 wherein the characteristic of the material is one of: composition, density, volume, humidity, moisture content, porosity, permeability, size, mass, surface roughness, surface position, absolute position, distance, or a combination thereof.

7. A sensor system as claimed in claim 1, wherein the waveguide comprises a hollow, open-ended body that acts as a conduit for transmitting and receiving signals.

8. A sensor system as claimed in claim 7, wherein the body has a first end and a second end, opposite the first, and wherein the transceiver is positioned adjacent the body at the first end.

9. A sensor system as claimed in claim 7, further comprising a signal permeable window positioned at the second end of the body, wherein the signal permeable window closes the second end of the body.

10. A sensor system as claimed in claim 9, wherein the waveguide is filled with a dielectric or dielectric material for creating a resonance.

11. A sensor system as claimed in claim 10, wherein the signal permeable window is a dielectric reflector, the dielectric reflector being operable to cause formation of a sensing field by increasing the intensity of the electromagnetic fields beyond its outer surface or below its inner surface, the dielectric reflector having a thickness of at least λg/20, where λg is the wavelength of the excited electromagnetic wave in the dielectric reflector, wherein the dielectric reflector is made of a dielectric material that is different to that of the dielectric material in the waveguide, and wherein the dielectric reflector 101 causes formation of a sensing field beyond its outer surface or below its inner surface, and
wherein the electromagnetic fields extend beyond the dielectric reflector, wherein the sensor is arranged to allow the sensing fields for the transmitting and receiving signals at the excitation wavelength and to measure any variation in the received signal due to the material interaction of the transmitted signal.

12. A sensor system as claimed in claim 9, wherein the signal permeable window is adapted to be inserted into a fluid containing body.

13. A sensor system as claimed in claim 12, wherein the fluid containing body is a pipeline, and the fluid is moving.

14. A sensor system as claimed in claim 1, further comprising a concentrator arranged around the waveguide.

15. A sensor system as claimed in claim 14, wherein the concentrator is a DBR (distributed Bragg reflection) structure.

16. A sensor system as claimed in claim 1, wherein the transceiver is operable to generate a broadband microwave signal, millimetre wave signal or RF (Radio Frequency) spectrum signal.

17. A sensor system as claimed in claim 1, wherein the transceiver is adapted to cause the sensor to operate in a far-field mode.

18. A sensor system as claimed in claim 1, wherein the transceiver is adapted to cause the sensor to operate in a near-field mode.

19. A method of determining a characteristic of a material, the method comprising:
transmitting a continuous wave signal to be incident on the material;
receiving a reflected continuous wave signal reflected from the material; and
determining a characteristic of the material using at least one of a resonance frequency difference, a magnitude difference, or a Q factor difference due to an interaction of the material with the continuous wave signal.

20. A method as claimed in claim 19, wherein the determining step further comprises:
sampling an IF signal by digitising an analogue measurement curve based on the reflected continuous wave signal; and
using at least one characteristic of the sampled IF signal to determine the characteristic of the material.

21. A method as claimed in claim 19, further comprising:
combining the continuous wave signal and the reflected continuous wave signal; and
analysing the resulting beat frequency or a sampled IF signal to determine the characteristic of the material.

22. A method as claimed in claim 21, wherein the step of analysing comprises obtaining the beat frequency or the sampled IF signal after a mixer by:
incrementing a frequency of the continuous wave signal in a plurality of steps for the entirety of a sweep range of the continuous wave signal;
digitising a resultant IF signal obtained after the mixer; and
sampling the resultant IF signal at an analogue to digital converter (ADC).

23. A method as claimed in claim 19, further comprising analysing a resulting peak magnitude 601, and/or an equivalent resonant frequency 603 and/or a Q factor equivalent of the resulting IF signal to determine the characteristic of the material.

24. A method as claimed in claim 19, wherein the characteristic of the material is one of: composition, density, volume, humidity, moisture content, porosity, permeability, size, mass, surface roughness, surface position, absolute position, distance, or a combination thereof.

25. A system for determining a characteristic of a material; comprising:
(a) a materials characteristic sensor system formed of a sensor comprising a waveguide: and
a transceiver for transmitting a continuous wave signal to be incident on a material to be characterised,
wherein the sensor is operable to receive a reflected continuous wave signal reflected from the material, and wherein a characteristic of the material is determined;
(b) a control board adapted to control (i) the transmission of the continuous wave signal by the transceiver, and (ii) reception of the reflected continuous wave signal by the sensor; and
(c) a processor adapted to determine a characteristic of the material using at least one of a resonance frequency difference, a magnitude difference, or a Q factor difference due to the material interacting with the transmitted continuous wave signal.
